(19) United States
(12) Patent Application Publication
(10) Pub. No.: US 2023/0400436 A1
(43) Pub. Date: Dec. 14, 2023

(54) GAS SENSOR DEVICES CONTAINING CRYPTOPHANE A SENSING LAYER

(71) Applicant: UT-Battelle, LLC, Oak Ridge, TN (US)

(72) Inventors: Ilja Popovs, Knoxville, TN (US); Benjamin LaRiviere, Knoxville, TN (US); Aleksandr Ivanov, Knoxville, TN (US); Robert J. Warmack, Knoxville, TN (US); Timothy E. Mcknight, Greenback, TN (US); Tolga Aytug, Knoxville, TN (US); Timothy J. Mcintyre, Farragut, TN (US)

(21) Appl. No.: 18/208,379

(22) Filed: Jun. 12, 2023

Related U.S. Application Data
(63) Continuation of application No. 63/351,558, filed on Jun. 13, 2022.

(51) Int. Cl. G01N 29/24

(52) U.S. Cl. CPC G01N 29/2443

(57) ABSTRACT

A gas sensing device comprising a layer of guest-free cryptophane A molecules on a substrate capable of detecting a molecular level change in mass, viscosity, or stress due to absorption of gas molecules into the cryptophane A molecules, wherein the cryptophane A molecules have the following structure:

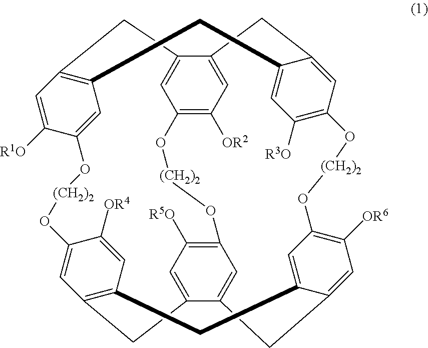

wherein R¹, R², R³, R⁴, R⁵, and R⁶ are independently selected from methyl and ethyl groups. Also described herein is a method for manufacturing the gas sensing device, particularly a step of sublimating cryptophane A molecules onto a suitable substrate. Also described herein is a method of detecting one or more gases in a space by placing a gas sensing device, as described above, in the space, wherein the gas sensing device transmits detection signals to an external electronic device that performs an analysis of the detection signals.

### CROSS-REFERENCE TO RELATED APPLICATIONS

The present application claims benefit of U.S. Provisional Application No. 63/351,558, filed Jun. 13, 2022, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to gas sensing devices and methods of their use, and more particularly, wherein the gas sensing devices include a layer of cryptophane molecules as a gas sensing component.

### BACKGROUND

Selective sensing of gases is important in numerous applications, such as food security, healthcare, nuclear energy, energy storage, and energy transport. Gas sensing in transformers is particularly important since flammable gases, such as acetylene, ethylene, ethane, and methane, are produced upon arc discharge. Conventional methods for gas detection primarily rely on consumable reagents and cartridges, and these tend to be costly, require sample preparation, and typically need regular withdrawing of samples for analysis. Although real time characterization based on infrared spectroscopy has been used, this requires highly sophisticated and expensive scientific equipment that is not feasible for large-scale deployment and applications.

### SUMMARY

In one aspect, the present disclosure is directed to a gas sensing device which advantageously does not require a consumable reagent or cartridge and is cost efficient to manufacture and operate. The gas sensing device can furthermore be placed in a location of interest and perform real time sensing, with the ability to send gas detection data wirelessly for analysis. The gas sensing device can also advantageously detect and distinguish between a variety of gases, such as ethane, ethylene, acetylene, and carbon dioxide.

More particularly, the gas sensing device includes a layer of guest-free cryptophane A molecules on a substrate capable of detecting a molecular level change in mass, viscosity, or stress due to absorption of gas molecules into the cryptophane A molecules, wherein the cryptophane A molecules have the following structure:

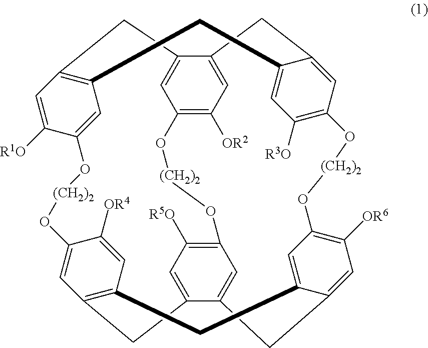

wherein R¹, R², R³, R⁴, R⁵, and R⁶ are independently selected from methyl and ethyl groups. In some embodiments, R¹, R², R³, R⁴, R⁵, and R⁶ in the cryptophane A molecules are all methyl. In other embodiments, at least three of R¹, R², R³, R⁴, R⁵, and R⁶ in the cryptophane A molecules are ethyl, or R¹, R², R³, R⁴, R⁵, and R⁶ in the cryptophane A molecules may be all ethyl. In some embodiments, the layer of guest-free cryptophane A molecules contains cryptophane A molecules in which R¹, R², R³, R⁴, R⁵, and R⁶ are all methyl and cryptophane A molecules in which at least three of R¹, R², R³, R⁴, R⁵, and R⁶ are ethyl. In other embodiments, the layer of guest-free cryptophane A molecules comprises first and second non-contacting layers, wherein the first layer contains cryptophane A molecules in which R¹, R², R³, R⁴, R⁵, and R⁶ are all methyl and the second layer contains cryptophane A molecules in which at least three of R¹, R², R³, R⁴, R⁵, and R⁶ are ethyl. The non-contacting layers may be in one device or in separate devices.

In some embodiments, the layer of guest-free cryptophane A molecules has a thickness of 1 nm to 1 or 2 microns, or a thickness of 1-500 nm, 1-200 nm, 1-100 nm, 50 nm to 1 or 2 microns, 50-500 nm, 50-200 nm, or 50-100 nm. In some embodiments, the layer of guest-free cryptophane A molecules has a uniformity in thickness of ±500 nm, ±200 nm, ±100 nm, or ±50 nm. For purposes of the invention, the layer of guest-free cryptophane A molecules is deposited on a suitable substrate by sublimation. The substrate is any material that can detect the absorption of gas molecules into the layer of guest-free cryptophane A molecules. The substrate is typically a piezoelectric material, such as quartz, barium titanate, lithium niobate, potassium niobate, sodium potassium niobate, lithium tantalate, lead zirconate tantalate, bismuth titanate, and zinc oxide. Typically, the gas sensing device further includes electronic components that permit wireless transmission of detection signals from the substrate. The gas sensing device may be, for example, a quartz crystal microbalance (QCM) or surface acoustic wave (SAW) device.

In another aspect, the present disclosure is directed to a method of using the gas sensing device described above for detecting one or more types of gases in a space. In the method, the above-described gas sensing device is placed in a space and wirelessly transmits detection signals to an external electronic device that performs an analysis of the detection signals. In some embodiments, R¹, R², R³, R⁴, R⁵, and R⁶ in the cryptophane A molecules are all methyl, and the gas sensing device more strongly detects acetylene compared to ethylene, methane, and ethane. In other embodiments, at least three of R¹, R², R³, R⁴, R⁵, and R⁶ in the cryptophane A molecules is ethyl, and the gas sensing device more strongly detects C₂ gases compared to methane, wherein the C₂ gases may be selected from acetylene, ethane, and/or ethylene. In some embodiments, the gas sensing device contains a first grouping of cryptophane A molecules in which R¹, R², R³, R⁴, R⁵, and R⁶ are all methyl and a second grouping of cryptophane A molecules in which at least three of R¹, R², R³, R⁴, R⁵, and R⁶ are ethyl, wherein the first and second groupings of cryptophane molecules may be within a single layer, or the first and second groupings of cryptophane molecules may be in separate non-contacting layers. In the method, the gas sensing device senses one or more gases selected from, for example, ethane, acetylene, ethylene, hydrogen, carbon dioxide, carbon monoxide, sulfur dioxide, nitrogen dioxide, halogens, and noble gases.

The invention is applicable to any number of gas sensing applications including but not limited to: semiconductor gas sensors; catalytic gas sensors; electrochemical gas sensors; optical gas sensors and acoustic gas sensors. Specific applications include but are not limited to: a) industrial production of acetylene, methane, haloalkanes etc. (detection and/or quantification of gas impurity), b) automotive (detection of polluting gases from vehicles), c) environmental (detection of potent greenhouse gases/pollutants), d) monitoring and control of power grid infrastructure and transformer health (incipient failure of power transformers), and e) oil and gas infrastructure monitoring (pipeline monitoring, quality monitoring, leak detection). The gas sensors described herein may also be integrated or assembled into an array of gas sensors to permit gas detection over an area of interest.

### BRIEF DESCRIPTION OF THE FIGURES

FIG. 1. Annotated image of a pair of two-track SAW devices, each functionalized with a layer cryptophane A molecules.

FIG. 2. Infrared (IR) spectra of guest-free cryptophane A and its complex with acetylene, which demonstrates the reversible nature of gas absorption and desorption.

FIG. 3. Single crystal X-ray diffraction structure of cryptophane A with an encapsulated acetylene molecule.

FIG. 4. Response curve vs acetylene concentration using SAW device with cryptophane A active layer. The signal of acetylene can be resolved down to 500 ppm.

FIG. 5. A cryptophane A QCM sensor showing selectivity profile for acetylene and to a lower degree for ethylene over methane and ethane. The response to ethylene and acetylene is different, which permits the two gases to be distinguished. The top pane of FIG. 5 shows the QCM frequency offset, i.e., instantaneous frequency f minus its fundamental frequency f0 in units of Hz. The QCM fundamental frequency f0 is approximately 10 MHz. This QCM frequency offset decreases as cryptophane thin film deposited on the surface of the QCM increases, due to increased gas absorption. The bottom pane shows the gas concentrations the QCM is exposed to as a function of time in minutes. The top and bottom profiles in FIG. 5 are aligned in time and share a horizontal time axis. The frequency decrease response of the QCM coated in cryptophane A is muted for the first three gasses applied (methane, ethane, ethylene), then clearly responds for applied ethylene.

FIG. 6. A hexaethylated cryptophane A QCM selectivity profile showing high selectivity for ethane, ethylene, and acetylene over methane. As in FIG. 5, this figure shows the QCM frequency offset response along with the concentrations of the four gases applied sequentially. The significant response to acetylene as well as ethane and ethylene, though at differing sensitivities, permits distinguishing between acetylene and the other two gases that the hexaethylated cryptophane A coated sensor is responsive to. For environments with a priori knowledge of the potential gas species present, this scheme permits distinguishing between these three gases.

### DETAILED DESCRIPTION

In a first aspect, the present disclosure is directed to a gas sensing device containing a layer of guest-free cryptophane A molecules on a substrate capable of detecting a molecular level change in mass, viscosity, or stress due to absorption of gas molecules into the cryptophane A molecules. The term “guest-free,” as used herein, indicates that the cryptophane A molecules have no atomic or molecular guest (e.g., solvent molecules) entrapped within (or encapsulated by) the cryptophane A molecule before the device is used for gas sensing applications. Notably, the guest-free state of the cryptophane A molecule is achieved by the present invention preferably by sublimating the cryptophane A molecules onto the substrate instead of depositing a coating of a solution of the cryptophane A molecules as done in the conventional art. The present invention has made the unexpected finding that sublimating a layer of cryptophane A molecules on a substrate for a gas sensing device results in a substantially improved detection ability.

The cryptophane A molecules have the following structure:

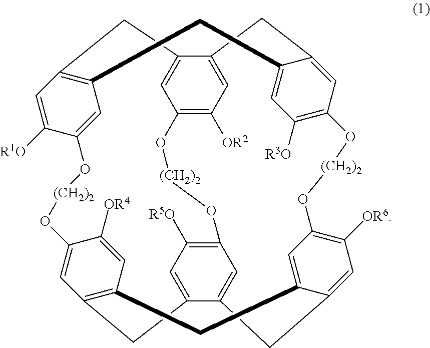

In Formula (1), R¹, R², R³, R⁴, R⁵, and R⁶ are independently selected from methyl and ethyl groups. In some embodiments, precisely or at least one, two, three, four, or five of R¹, R², R³, R⁴, R⁵, and R⁶ are methyl groups, wherein any remaining groups are necessarily ethyl. In some embodiments, R¹, R², R³, R⁴, R⁵, and R⁶ are all methyl groups. In some embodiments, precisely or at least one, two, three, four, or five of R¹, R², R³, R⁴, R⁵, and R⁶ are ethyl groups, wherein any remaining groups are necessarily methyl. In some embodiments, R¹, R², R³, R⁴, R⁵, and R⁶ are all ethyl groups.

In some embodiments, the layer of cryptophane A molecules contains solely cryptophane A molecules in which precisely or at least one, two, three, four, or five of R¹, R², R³, R⁴, R⁵, and R⁶ are methyl groups, wherein any remaining groups are necessarily ethyl. In some embodiments, the layer of cryptophane A molecules contains solely cryptophane A molecules in which R¹, R², R³, R⁴, R⁵, and R⁶ are all methyl groups. In some embodiments, the layer of cryptophane A molecules contains solely cryptophane A molecules in which precisely or at least one, two, three, four, or five of R¹, R², R³, R⁴, R⁵, and R⁶ are ethyl groups, wherein any remaining groups are necessarily methyl. In some embodiments, the layer of cryptophane A molecules contains solely cryptophane A molecules in which R¹, R², R³, R⁴, R⁵, and R⁶ are all ethyl groups.

In other embodiments, the layer of guest-free cryptophane A molecules contains a mixture of cryptophane A molecules within the scope of Formula (1). For example, in some embodiments, the layer of guest-free cryptophane A molecules contains cryptophane A molecules in which R¹, R², R³, R⁴, R⁵, and R⁶ are all methyl and cryptophane A molecules in which at least three of R¹, R², R³, R⁴, R⁵, and R⁶ are ethyl. In other embodiments, the layer of guest-free cryptophane A molecules comprises first and second non-contacting layers, wherein the first layer contains cryptophane A molecules in which R¹, R², R³, R⁴, R⁵, and R⁶ are all methyl and the second layer contains cryptophane A molecules in which at least three of R¹, R², R³, R⁴, R⁵, and R⁶ are ethyl. The term “non-contacting” means that one layer does not overlay or underlay the other layer. By being non-contacting, the layers are each exposed and thus able to freely absorb gases in the surrounding environment.

The layer of guest-free cryptophane A molecules generally has a thickness of 1 nm to 2 microns. In different embodiments, the layer has a thickness of precisely or about, for example, 1 nm, 2 nm, 5 nm, 10 nm, 20 nm, 30 nm, 40 nm, 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm (1 micron), 1250 nm, 1500 nm, or 2000 nm, or the thickness is within a range bounded by any two of the foregoing values (e.g., 1 nm to 2 microns, 1 nm to 1 micron, 1-500 nm, 1-250 nm, 1-100 nm, 10 nm to 2 microns, 10 nm to 1 micron, 10-500 nm, 10-250 nm, 10-100 nm, 50 nm to 2 microns, 50 nm to 1 micron, 50-500 nm, 50-250 nm, 50-100 nm, 100 nm to 2 microns, or 100 nm to 1 micron). The layer of guest-free cryptophane A molecules also generally has a uniformity in thickness of ±500 nm, ±400 nm, ±300 nm, ±250 nm, ±100 nm, ±50 nm, ±25 nm, or ±20 nm.

The substrate on which the layer of guest-free cryptophane A molecules is deposited is capable of detecting a molecular level change in mass, viscosity, or stress due to absorption of gas molecules into the cryptophane A molecules. The substrate may be, for example, a piezoelectric material. Some examples of piezoelectric materials include, for example, quartz, barium titanate, lithium niobate, potassium niobate, sodium potassium niobate, lithium tantalate, lead zirconate tantalate, bismuth titanate, and zinc oxide. The substrate may also be a piezoelectric surface coated with thin films of other non-piezoelectric materials, such as quartz coated with metal electrodes on which the cryptophane is deposited, or a lithium niobate substrate coated with a thin silicon oxide film on which the cryptophane is deposited. Non-piezoelectric or piezoelectric materials and material composites or heterostructures (onto which the cryptophane is deposited or coated) may be used for microcantilever or similar micro-resonator device structures.

The gas sensing device may be, for example, a quartz crystal microbalance (QCM) or surface acoustic wave (SAW) device. The gas sensing device typically further includes electronic components that permit data transfer, particularly wireless transmission, of detection signals from the substrate. The electronic component may be, for example, electrical wiring, optical fiber, and/or a radio transmitter, as well known in the art. Other mass-sensitive or stress-sensitive acoustic or acoustoelectric sensors, such as microcantilever sensors, may also be capable of sensing gases using the cryptophane molecules described herein. Other possible devices include non-quartz bulk-acoustic wave (BAW) sensors. While frequency tracking is the most typical inference method, optical or electrical static displacement, or a combination of frequency, amplitude, and phase tracking may also be used for inferring measurements. Both passive (e.g. SAW delay line) or active (e.g. oscillator/resonator) excitation of these devices are possible.

In another aspect, the present disclosure is directed to a method of manufacturing the gas sensing device. At minimum, the method includes a step of depositing guest-free cryptophane A molecules onto a suitable substrate, such as any of the substrates discussed above. For purposes of the present invention, the cryptophane A molecules are preferably deposited by sublimation to ensure that the cryptophane A molecules are in a guest-free state. The present invention provides the unexpected finding that forming a layer of guest-free cryptophane A molecules, rather than solvent- or gas-entrapped cryptophane A molecules, results in a substantial improvement in the ability of the device to detect and identify gas species and to distinguish between different types of gas species. The guest-free material is obtained during the initial sublimation/deposition state and can sense various gases (analytes) without the need to regenerate the sensing material. When the analyte is present, there is a sensor response. When the gas (analyte) is absent, i.e., when the sensor is exposed to standard (ambient) air, the cryptophane sensing layer is capable of sensing the gases (analytes) again.

In another aspect, the present disclosure is directed to a method for detecting (i.e., sensing, identifying, or monitoring over time) one or more gases in a space of interest. In the method, the gas sensing device, described above, is placed in a space of interest to detect gases present in the space. The term “detecting,” as used herein, also includes the possibility of monitoring a space over time for the presence of one or more gases. The term “detecting,” as used herein, also includes the possibility of identifying one or more gas species, and also possibly distinguishing one gas species from another. The space may be within or surrounding, for example, a utility room, industrial facility, electrical or power supply box or closet, electrical transformer, engine, machine, power plant, oil or gas infrastructure, or living space. The gases that can be detected or monitored by the gas sensing device may include one or more selected from ethane, acetylene, ethylene, hydrogen, oxygen, carbon dioxide, carbon monoxide, sulfur dioxide, nitrogen oxides (i.e., NOx gases, e.g., nitrogen dioxide), halogens, and noble gases. The halogens include fluorine, chlorine, bromine, and iodine. The noble gases include helium, neon, argon, krypton, xenon, and radon. The gas sensing device is preferably also capable of distinguishing two or more of any of the foregoing gases from each other. The gas sensing device may more particularly distinguish between and/or identify any of the following gases: ethane, ethylene, acetylene, carbon dioxide, N₂O, NO, NO₂, Xe, and Kr.

In some embodiments, at least four, five, or all of R¹, R², R³, R⁴, R⁵, and R⁶ in the cryptophane A molecules are methyl, and the gas sensing device more strongly detects acetylene compared to ethylene, methane, and ethane. In other embodiments, at least three, four, or all of R¹, R², R³, R⁴, R⁵, and R⁶ in the cryptophane A molecules are ethyl, and the gas sensing device more strongly detects C₂ gases (or any one or more of the exemplary C₂ gases listed above) compared to methane. The C₂ gases are typically selected from acetylene, ethane, and ethylene.

In some embodiments, the gas sensing device may include two types of cryptophane A molecules in a single layer or in separate layers, as described earlier above. For example, the gas sensing device may include a first grouping of cryptophane A molecules in which R¹, R², R³, R⁴, R⁵, and R⁶ are all methyl and a second grouping of cryptophane A molecules in which at least three of R¹, R², R³, R⁴, R⁵, and R⁶ are ethyl. In some embodiments, the first and second groupings of cryptophane molecules are within a single layer, i.e., as a homogeneous mixture. In other embodiments, the first and second groupings of cryptophane molecules are in separate non-contacting layers, as described above. The separate non-contacting layers may be within the same device or in separate devices (i.e., a first grouping of cryptophane A molecules is in a layer of a first device while a second grouping of cryptophane A molecules is in a layer of a second device). The gas sensing device transmits data to an internal or external data processor (i.e., computing device). Preferably, the gas sensing device wirelessly transmits acquired data to the data processor for real time monitoring.

Examples have been set forth below for the purpose of illustration and to describe certain specific embodiments of the invention. However, the scope of this invention is not to be in any way limited by the examples set forth herein.

### Examples

Assembly of SAW and QCM Devices

Cryptophane films containing cryptophane A molecules were deposited as thin films on both surface acoustic wave (SAW) and quartz crystal microbalance (QCM) devices by either drop-casting or sublimation. SAW devices were designed and fabricated using lithium niobate crystal. QCM devices were procured from a commercial supplier. The SAW devices consisted of one-port, dual-track delay-line SAW filters operating in the 915 MHz regime. For both the drop-casting and sublimation deposition methods, one of the two SAW delay-line track was functionalized with cryptophane film deposition, with the other track left pristine and serving as a reference measurement for comparative monitoring of the functionalized track. Comparison of the magnitude attenuation of reflection signals at several frequencies near 915 MHz in the functionalized SAW track was performed continuously to reflection signals from the pristine track to monitor changes in the response due to applied gas concentrations.

For QCM measurements, cryptophane-A was deposited on the QCM top electrode, and the temperature-compensated resonance frequency of the QCM was tracked continuously, with shifts in the resonance frequency corresponding to changes in the applied gas concentrations. SAW measurements were performed with a vector network analyzer (VNA) with frequency sweeps between 815 MHz and 1015 MHz. The SAW device responses were time-gated to reduce measurement noise and isolate portions of the resonance most sensitive to the cryptophane functionalization. QCM frequency was tracked using a commercial frequency analyzer that tracked the nominally 10 MHz device's natural frequency and temperature.

The drop-cast method for both the SAW- and QCM-based devices included dissolving the cryptophane in tetrachloroethylene (TCE) and depositing via micro-pipette. After deposition, the TCE was allowed to slowly evaporate to maximize homogeneity of the deposited film, then the TCE was fully removed by exposing the deposition to an elevated temperature (80° C. to 175° C.). The foregoing step amounts to a sintering step.

The sublimation method for both device types included masking the devices with a patterned polyamide adhesive and placing the devices at an approximately 1-inch separation from the cryptophane powder, under a vacuum of approximately 1 mT. The devices were cooled by an ice-water bath throughout the deposition period, while the cryptophane powder was heated to between 150° C. and 250° C. The sublimation process resulted in the deposition of cryptophane A molecules on the surface of the device.

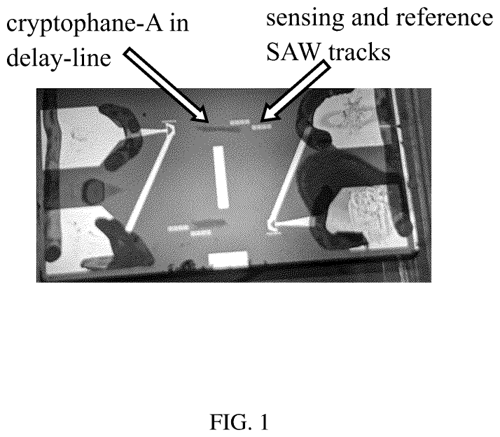

An image of one of the SAW devices used for testing cryptophane sensitivity is shown in FIG. 1. Gas concentration testing was performed with a dilution system controlling and monitoring gas flow rates from compressed inert as well as test gases (e.g. acetylene in N₂), humidity, and temperature. All tests were performed at ambient pressure (i.e., about 1 atm).

Results and Discussion

Cryptophane A has been previously used in surface acoustic wave (SAW) and quartz crystal microbalance (QCM) gas sensors specifically for methane detection (M. Benounis et al., Sens. Actuators B Chem. 2005, 107 (1), 32-39). However, as confirmed by computational results shown in Table 1, cryptophane A has only a very weak affinity towards methane.

TABLE 1
Computationally verified selectivity profile of cryptophane A toward different gases

| | Xe@Cryp-A | CH₄@Cryp-A | N₂@Cryp-A | C₂H₂@Cryp-A | C₂H₆@Cryp-A | C₂H₄@Cryp-A |
|---|---|---|---|---|---|---|
| dG | −7.43 | −2.12 | 0.18 | −6.49 | −7.25 | −5.71 |
| (kcal/mol) | | | | | | |

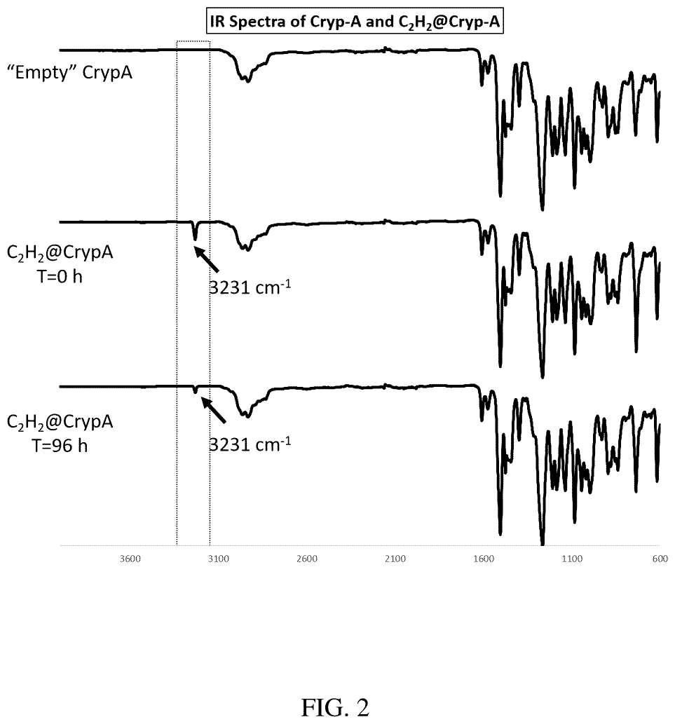

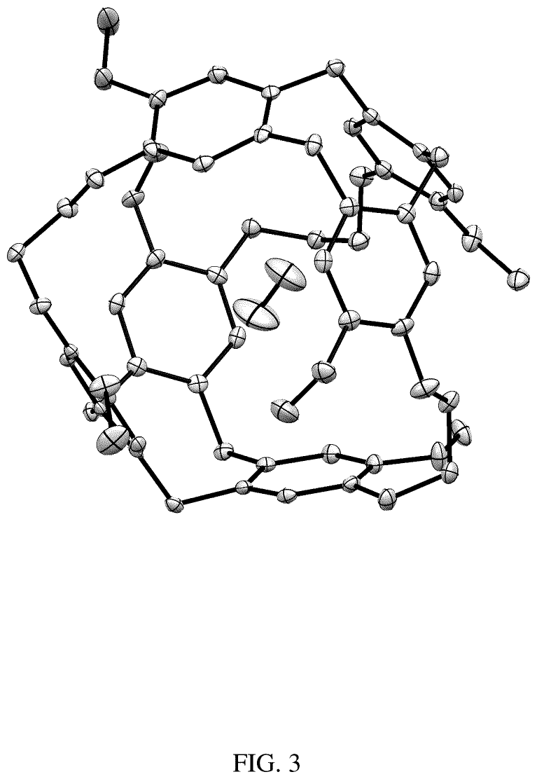

A range of characterization experiments were performed to confirm the affinity and selectivity of cryptophane A towards C₂ gases and Xe. A bulk layer of guest-free cryptophane A molecules was prepared and exposed to an acetylene atmosphere (FIG. 2). Upon exposure, fast and quantitative uptake of acetylene inside of the cryptophane A molecules was observed by infrared spectroscopy (IR). Single crystals of the acetylene-absorbed cryptophane molecules were prepared to permit X-ray diffraction studies. The refined structure (FIG. 3) shows an acetylene molecule entrapped inside the cavity of the cryptophane A supramolecular nanotrap.

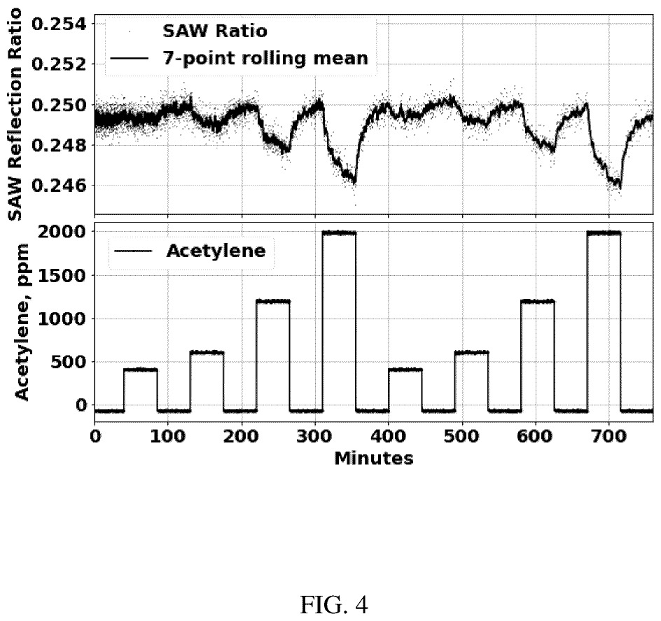

Next, guest-free Cryptophane A molecules were deposited using either solution casting or sublimation techniques on the delay line in the SAW or on top of the gold electrodes in the QCM. In both cases, the thickness of the film and the amount of material could be conveniently controlled by the amount of time spent in the deposition chamber or the initial concentration of the cryptophane A in solution. FIG. 4 illustrates the response curve of the wireless SAW device containing the deposited film of cryptophane A toward different concentrations (in ppm) of acetylene in air. It is clear that the signal appears as soon as acetylene is present at the 500 pm level.

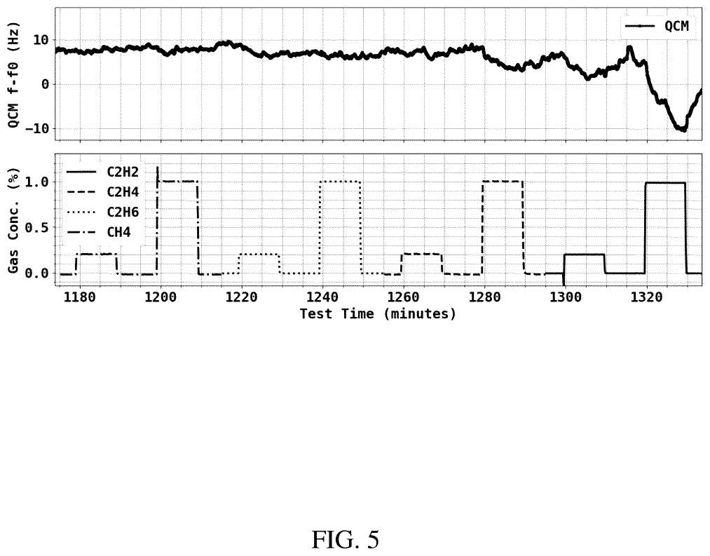

Likewise, as shown in FIG. 5, a QCM sensor with parent (fully methylated) cryptophane A molecules showed a strong and selective response towards acetylene and a much weaker response to ethylene. There is also no response to ethane and methane, which confirms ab initio calculations data provided vide supra. To gain higher dynamic range and improve applicability, a hexa-ethylated cryptophane A derivative was prepared and characterized. SAW and QCM sensors containing the hexa-ethylated cryptophane A derivative were assembled.

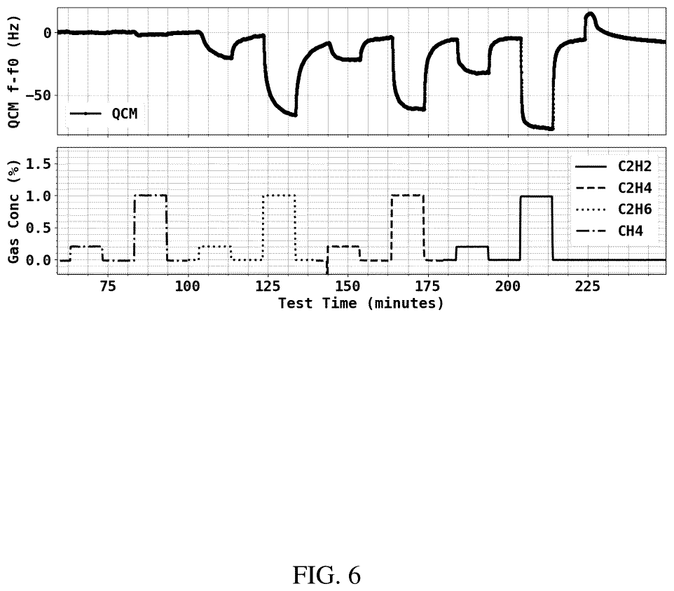

As shown in FIG. 6, the hexa-ethylated cryptophane A devices exhibited a somewhat different selectivity picture. The hexa-ethylated derivative exhibited a more pronounced response to all three C₂ gases, namely ethane, ethylene and acetylene. There was still no response to methane. By combining a dual sensor array with the parent cryptophane A and its hexa-ethylated analog, one can easily identify, quantify, and discriminate between ethane, ethylene, and acetylene gases using cheap and efficient wireless gas sensors. Notably, in these experiments, care was taken to avoid confounding results due to artifacts such as change in dilution gas concentrations (e.g. switching from a compressed dry air to an argon or nitrogen ambient) or changes in temperature.

In conclusion, both SAW and QCM gas sensor configurations showed very high selectivity for gases and permitted easy discrimination between ethane, ethylene, and acetylene, as well as krypton and xenon, in addition to many other gases. Especially the use of two substrates deposited on the sensors, i.e. cryptophane A (parent) and ethylated derivatives, permit simple and efficient identification and quantification of these gases in the air sample or an appropriate liquid sample.

While there have been shown and described what are at present considered the preferred embodiments of the invention, those skilled in the art may make various changes and modifications which remain within the scope of the invention defined by the appended claims.

What is claimed is:

1. A gas sensing device comprising a layer of guest-free cryptophane A molecules on a substrate capable of detecting a molecular level change in mass, viscosity, or stress due to absorption of gas molecules into the cryptophane A molecules, wherein the cryptophane A molecules have the following structure: 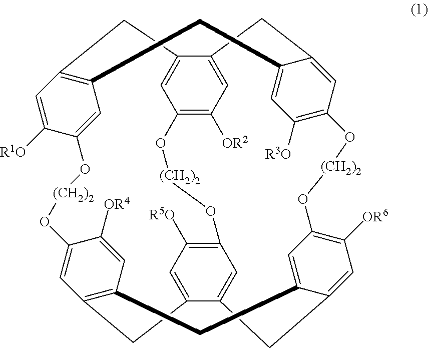
wherein R¹, R², R³, R⁴, R⁵, and R⁶ are independently selected from methyl and ethyl groups.

2. The gas sensing device of claim 1, wherein the layer of guest-free cryptophane A molecules has a thickness of 1 nm to 2 microns.

3. The gas sensing device of claim 1, wherein the layer of guest-free cryptophane A molecules has a thickness of 1-500 nm.

4. The gas sensing device of claim 1, wherein the layer of guest-free cryptophane A molecules has a uniformity in thickness of ±500 nm.

5. The gas sensing device of claim 1, wherein the layer of guest-free cryptophane A molecules has a uniformity in thickness of ±200 nm.

6. The gas sensing device of claim 1, wherein the layer of guest-free cryptophane A molecules is deposited by sublimation.

7. The gas sensing device of claim 1, wherein the substrate is a piezoelectric material.

8. The gas sensing device of claim 7, wherein the piezoelectric material is selected from the group consisting of quartz, barium titanate, lithium niobate, potassium niobate, sodium potassium niobate, lithium tantalate, lead zirconate tantalate, bismuth titanate, and zinc oxide.

9. The gas sensing device of claim 1, wherein the gas sensing device further comprises electronic components that permit wireless transmission of detection signals from the substrate.

10. The gas sensing device of claim 1, wherein the gas sensing device is a quartz crystal microbalance (QCM) or surface acoustic wave (SAW) device.

11. The gas sensing device of claim 1, wherein R¹, R², R³, R⁴, R⁵, and R⁶ in the cryptophane A molecules are all methyl.

12. The gas sensing device of claim 1, wherein at least three of R¹, R², R³, R⁴, R⁵, and R⁶ in the cryptophane A molecules are ethyl.

13. The gas sensing device of claim 1, wherein R¹, R², R³, R⁴, R⁵, and R⁶ in the cryptophane A molecules are all ethyl.

14. The gas sensing device of claim 1, wherein the layer of guest-free cryptophane A molecules contains cryptophane A molecules in which R¹, R², R³, R⁴, R⁵, and R⁶ are all methyl and cryptophane A molecules in which at least three of R¹, R², R³, R⁴, R⁵, and R⁶ are ethyl.

15. The gas sensing device of claim 1, wherein the layer of guest-free cryptophane A molecules comprises first and second non-contacting layers, wherein the first layer contains cryptophane A molecules in which R¹, R², R³, R⁴, R⁵, and R⁶ are all methyl and the second layer contains cryptophane A molecules in which at least three of R¹, R², R³, R⁴, R⁵, and R⁶ are ethyl.

16. A method of detecting one or more gases in a space, the method comprising placing a gas sensing device in the space, wherein the gas sensing device comprises a layer of guest-free cryptophane A molecules on a substrate capable of detecting a molecular level change in mass, viscosity, or stress due to absorption of gas molecules into the cryptophane A molecules, wherein the cryptophane A molecules have the following structure: 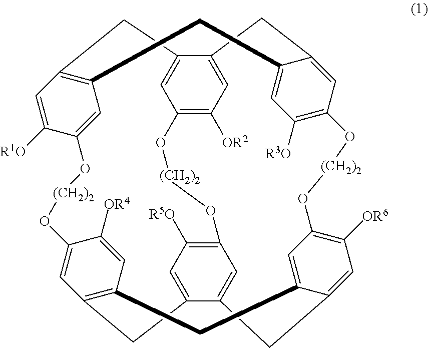
wherein R¹, R², R³, R⁴, R⁵, and R⁶ are independently selected from methyl and ethyl groups;
wherein the gas sensing device wirelessly transmits detection signals to an external electronic device that performs an analysis of the detection signals.

17. The method of claim 16, wherein the layer of guest-free cryptophane A molecules has a thickness of 1 nm to 1 micron.

18. The method of claim 16, wherein the layer of guest-free cryptophane A molecules has a thickness of 1-500 nm.

19. The method of claim 16, wherein the layer of guest-free cryptophane A molecules has a uniformity in thickness of ±500 nm.

20. The method of claim 16, wherein the layer of guest-free cryptophane A molecules has a uniformity in thickness of ±200 nm.

21. The method of claim 16, wherein R¹, R², R³, R⁴, R⁵, and R⁶ in the cryptophane A molecules are all methyl, and the gas sensing device more strongly detects acetylene compared to ethylene, methane, and ethane.

22. The method of claim 16, wherein at least three of R¹, R², R³, R⁴, R⁵, and R⁶ in the cryptophane A molecules are ethyl, and the gas sensing device more strongly detects C₂ gases compared to methane.

23. The method of claim 22, wherein the C₂ gases are selected from acetylene, ethane, and ethylene.

24. The method of claim 16, wherein the gas sensing device comprises a first grouping of cryptophane A molecules in which R¹, R², R³, R⁴, R⁵, and R⁶ are all methyl and a second grouping of cryptophane A molecules in which at least three of R¹, R², R³, R⁴, R⁵, and R⁶ are ethyl.

25. The method of claim 24, wherein the first and second groupings of cryptophane molecules are within a single layer.

26. The method of claim 24, wherein the first and second groupings of cryptophane molecules are in separate non-contacting layers.

27. The method of claim 16, wherein the gas sensing device senses one or more gases selected from the group consisting of ethane, acetylene, ethylene, hydrogen, oxygen, carbon dioxide, carbon monoxide, sulfur dioxide, nitrogen dioxide, halogens, and noble gases.
